(19) United States
(12) Patent Application Publication
(10) Pub. No.: US 2013/0321741 A1
(43) Pub. Date: Dec. 5, 2013

(54) BACKLIGHT MODULE AND LIQUID CRYSTAL DISPLAY USING SAME

(71) Applicant: Synergy Optoelectronics (Shenzhen) Co., Ltd., ShenZhen (CN)

(72) Inventors: QIONG YUAN, Shenzhen (CN); SIN-TUNG HUANG, Hsinchu (TW); CHIH-YUNG WANG, Hsinchu (TW)

(73) Assignee: Synergy Optoelectronics (Shenzhen) Co., Ltd., Shenzhen (CN)

(21) Appl. No.: 13/906,372

(22) Filed: May 31, 2013

(30) Foreign Application Priority Data
May 31, 2012 (CN) 2012101762164

(51) Int. Cl. F21V 8/00; G02F 1/1333; G02F 1/1335

(52) U.S. Cl. CPC G02B 6/0033; G02F 1/1336; G02F 1/133308; G02B 6/009; G02B 6/0091
USPC 349/58; 362/97.2; 349/67

(57) ABSTRACT

A backlight module includes a light source, a light guide plate, and a reflector. The light guide plate includes a top surface, a bottom surface, and a circumferential side surfaces. The single top surface includes both a light incident area and a light emitting area. The light source is positioned above the light incident area to feed light down into the light guide plate and the reflector covers the bottom surface and the side surface to reflect light otherwise escaping through the bottom surface and the side surface.

### BACKGROUND

1. Technical Field

The present disclosure relates to backlight technologies, and more particularly, to a backlight module and a liquid crystal display using the backlight module.

2. Description of Related Art

Generally, a backlight module includes a light guide plate and a number of light sources. The light guide plate typically includes a light emitting surface and a light incident surface perpendicular to the light emitting surface. The light sources face the light incident surface to feed light into the light guide plate. However, more and more backlight modules use a number of light emitting diodes (LEDs) as the light sources, and a peripheral area of the light emitting surface corresponding to the LEDs appears to have light and dark patterns. Typically, the patterned area on the light emitting surface is shielded by a frame that receives the backlight module. However, this results in a display area of an associated liquid crystal display being somewhat smaller, and the appearance of the liquid crystal display may be compromised.

Therefore, it is desirable to provide a means which can overcome the above-mentioned problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, all the views are schematic, and like reference numerals designate corresponding parts throughout the several views.

FIG. 1 is an exploded, isometric view of a liquid crystal display in accordance with a first embodiment.

FIG. 2 is an enlarged view of a circled portion II of FIG. 1.

FIG. 3 is an enlarged view of a circled portion III of FIG. 1.

FIG. 4 is an assembled view of the liquid crystal display of FIG. 1.

FIG. 5 is an abbreviated, enlarged, cross-sectional view taken along line V-V of FIG. 4.

FIG. 6 is similar to FIG. 5, but showing a liquid crystal display in accordance with a second embodiment.

### DETAILED DESCRIPTION

Embodiments of the present disclosure will be described with reference to the accompanying drawings.

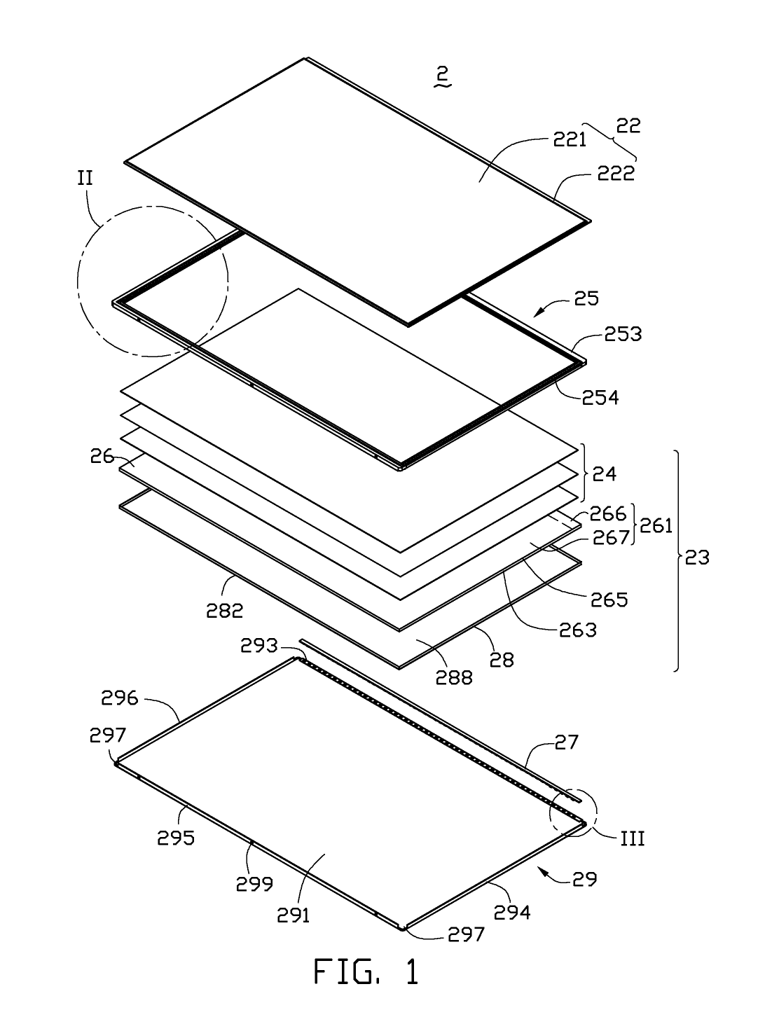

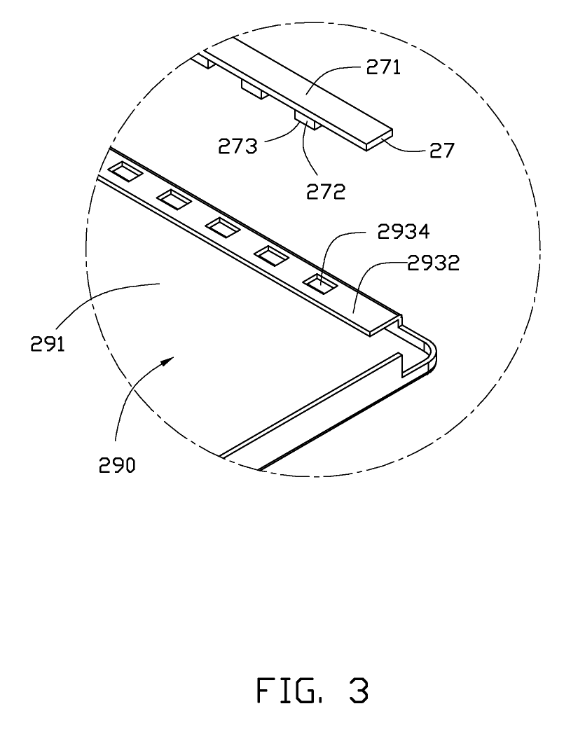

Referring to FIGS. 1 to 3, a liquid crystal display 2, in accordance with a first embodiment, includes a liquid crystal panel 22, a frame 25, a backlight module 23, and a base 29. The liquid crystal panel 22 includes a display area 221 and a driving circuit area 222. The driving circuit area 222 is a peripheral area of the liquid crystal panel 22. A number of driving chips (not shown) can be mounted on the driving circuit area 222, to drive the liquid crystal panel 22. The liquid crystal panel 22 is held in the frame 25. The backlight module 23 is located below the liquid crystal panel 22 and provides a backlight to the liquid crystal panel 22. The base 29 holds the frame 25 and the backlight module 23.

The base 29 includes a bottom board 291, and four side walls 293, 294, 295, and 296. The bottom board 291 includes a number of raised edges. The side walls 293, 294, 295, and 296 perpendicularly extend upwards from the raised edges. A holding board 2932 extends from a top edge of the side wall 293 towards the opposite side wall 295. The holding board 2932 defines a number of receiving holes 2934 therein. The receiving holes 2934 are arranged longitudinally along the holding board 2932.

In this embodiment, the bottom board 291 is rectangular. The four side walls are designated as a first side wall 293, a second side wall 294, a third side wall 295, and a fourth side wall 296. The first side wall 293 and the third side wall 295 are parallel to each other. The first side wall 293 and the third side wall 295 each extend along a longitudinal direction of the bottom board 291. The second side wall 294 and the fourth side wall 2961 are parallel to each other. The second side wall 294 and the third side wall 295 each extend along a direction perpendicular to the longitudinal direction of the bottom board 291. The third side wall 295 defines a number of fastening through holes 299. At the four corners of the bottom board 291, the four side walls 293, 294, 295, and 296 do not connect with each other. Rather, four cutouts 297 are correspondingly defined between adjacent of the side walls 293, 294, 295, and 296 at the four corners of the bottom board 291. The first side wall 293, the second side wall 294, the third side wall 295, the fourth side wall 296, and the bottom board 291 cooperatively define a first receiving space 290 to receive the backlight module 23.

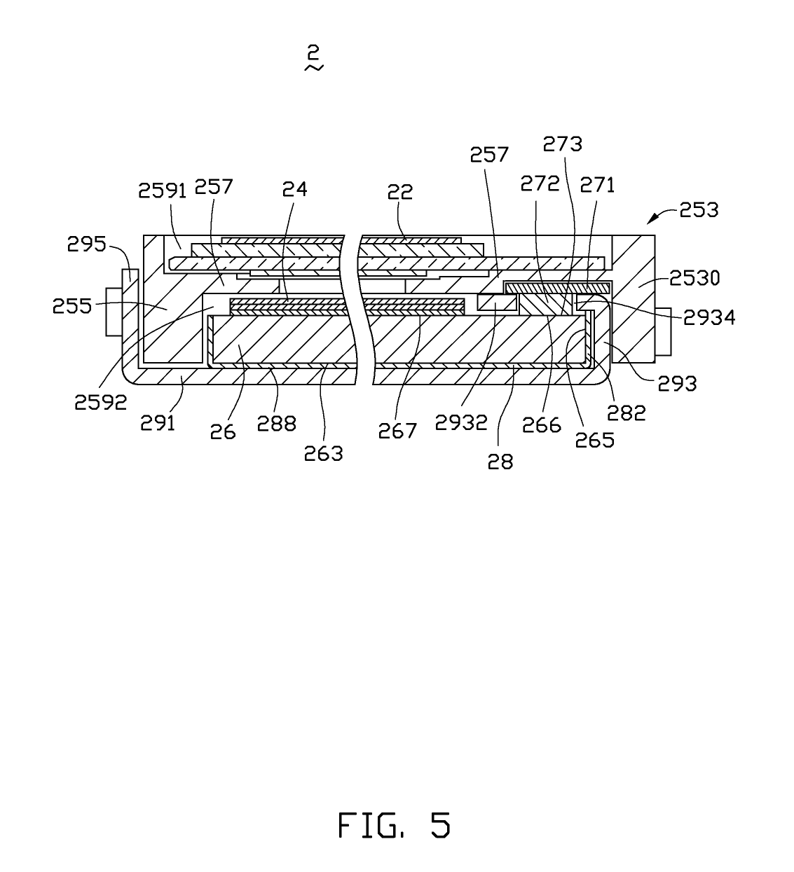

The frame 25 includes a first side 253, a second side 254, a third side 255, a fourth side 256, and a holding flange 257. The first side 253, the second side 254, the third side 255, and the fourth side 256 are connected end to end to form a rectangular frame. The third side 255 defines a number of fastening holes 259 corresponding to the fastening through holes 299. The holding flange 257 is frame-shaped, and extends from a four-sided inner surface 251 cooperatively formed by the first side wall 293, the second side wall 294, the third side wall 295, and the fourth side wall 296. The inner surface 251 and the holding flange 257 cooperatively define a second receiving space 2591 (see FIG. 5) above the holding flange 257, and also cooperatively define a third receiving space 2592 (see FIG. 5) below the holding flange 257. The second receiving space 2591 receives the liquid crystal panel 22. The third receiving space 2592 receives the backlight module 23.

The backlight module 23 includes a number of optical films 24, a light guide plate 26, a light source 27, and a reflector 28. The light guide plate 26 includes a top surface 261, a bottom surface 263, and a circumferential side surface 265. The side surface 265 connects the top surface 261 with the bottom surface 263. The top surface 261 includes a light incident area 266 and a light emitting area 267, with the light incident area 266 and the light emitting area 267 being coplanar.

Light emitted by the light source 27 enters the light guide plate 26 via the light incident area 266, and is emitted out of the light guide plate 26 via the light emitting area 267. The optical films 24 are positioned on the light emitting area 267. In this embodiment, the bottom surface 263 is parallel to the top surface 261. The top surface 261 is rectangular. The light incident area 266 is a narrow rectangular area adjacent to a long edge of the top surface 261. A length of the light incident area 266 is equal to a length of the long edge of the top surface 261. The remaining area of the top surface 261 is the light emitting area 267.

The reflector 28 reflects the light otherwise escaping from the bottom surface 263 and the side surface 265 back into the light guide plate 26 in order to avoid leakage of light. The reflector 28 includes a flat first part 288 and a circumferential second part 282. The first part 288 covers the bottom surface 263. The second part 282 covers the side surface 265. The first part 288 can be integrally formed with the second part 282, or discretely made. In this embodiment, the reflector 28 is an integrally formed, molded sheet made of a material with high reflectance. That is, the reflector 28 is a monolithic one-piece body of the same material. It is understood that, in an alternative embodiment, the reflector 28 is a reflective layer coated on the bottom surface 263 and the side surface 265.

The light source 27 is positioned on the light incident area 266 for feeding light into the light guide plate 26. The light source 27 includes a circuit board 271, and a number of illuminants 272 corresponding to the receiving holes 2934. The illuminants 272 are formed on the circuit board 271. Each of the illuminants 272 includes a light emitting surface 273 facing away from the circuit board 271. The circuit board 271 is an elongated plate extending along the longitudinal direction of the bottom board 291. The circuit board 271 provides electrical power to the illuminants 272. In this embodiment, the illuminants 272 are light emitting diodes.

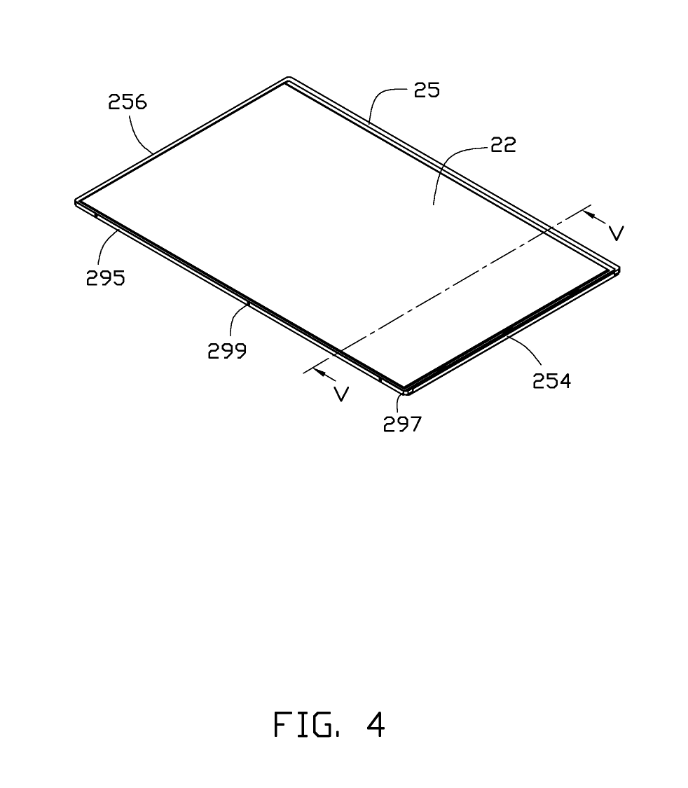

In assembly of the liquid crystal display 2, referring to FIGS. 4 and 5, the light source 27 is mounted on the holding board 2932 by the illuminants 272 being inserted into the receiving holes 2934. The light emitting surfaces 273 of the illuminants 272 pass through the receiving holes 2934 and face the bottom board 291. The optical films 24 are attached on the light emitting area 267 of the top surface 261. The reflector 28 is attached to the light guide plate 26, with the first part 288 covering the bottom surface 263 and the second part 282 covering the side surface 265. The light guide plate 26 with the reflector 28 and the optical films 24 attached thereon is positioned on the bottom board 291 and received in the first receiving space 290. A part of the light guide plate 26 on which the light incident area 266 is defined is inserted into a gap defined between the holding board 2932 and the bottom board 291. The light emitting surfaces 273 of the illuminants 272 are thus brought into contact with the light incident area 266. Thus, the light emitted from the light emitting surfaces 273 can enter the light guide plate 26 via the light incident area 266.

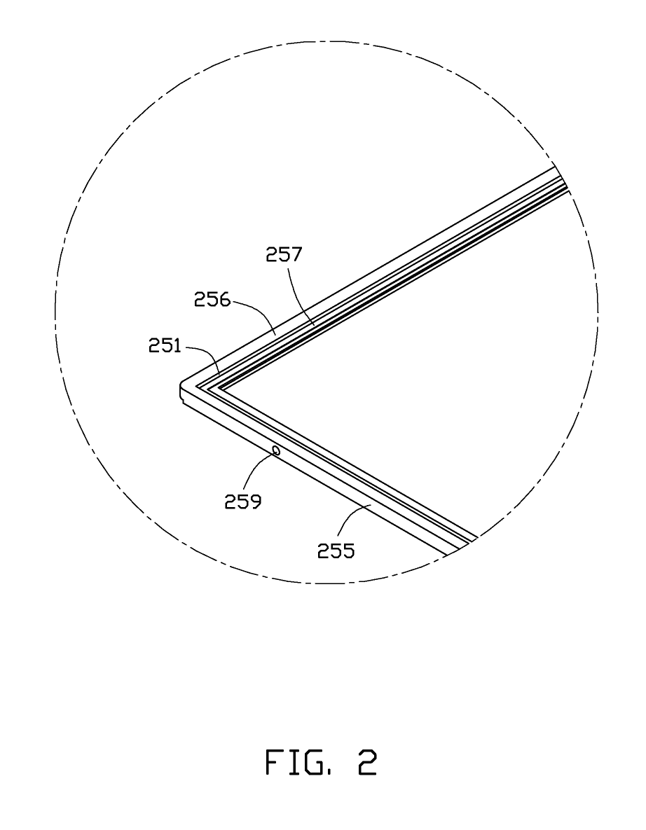

The liquid crystal panel 22 is held on the holding flange 257 and received in the second receiving space 2591. The frame 25 is mounted on the base 29, with the third receiving space 2592 adjacent to the bottom board 291. The third side 255 is received in a space defined between the light guide plate 26 and the third side wall 295. The fastening holes 259 (see FIG. 2) are aligned with the fastening through holes 299. The frame 25 is fastened to the base 29 by a number of threaded screws (not shown) being passed through the fastening through holes 299 and screwed into the fastening holes 259 (see FIG. 2). The opposite ends of the third side 255 are each exposed out of the base 29 at the corresponding cutouts 297. The first side 253, the second side 254, and the fourth side 256 of the frame 25 are embraced by the first side wall 293, the second side wall 294, and the fourth side wall 296 of the base 29.

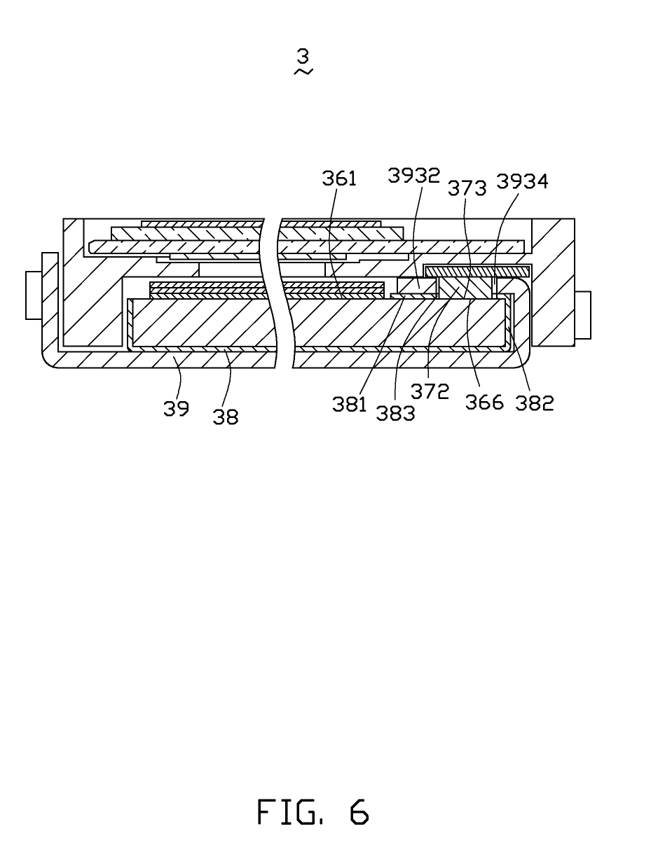

Referring to FIG. 6, a liquid crystal display 3, in accordance with a second embodiment, is similar to the liquid crystal display 2 of the first embodiment.

However, unlike the reflector 28 of the liquid crystal display 2, the reflector 38 of the liquid crystal display 3 further includes a third part 381. The third part 381 covers the light incident area 366 of the top surface 361 except for positions where the light emitting surfaces 373 of the illuminants 372 touch the light incident area 366. In this embodiment, the third part 381 is a reflective sheet extending from a top end of one long side of the second part 382. The third part 381 defines a number of receiving through holes 383 corresponding to the receiving holes 3934 of the holding board 3932 of the base 39. In assembly, the light emitting surfaces 373 pass through the receiving through holes 383 to make contact with the light incident area 366. It is understood that, in an alternative embodiment, the third part 381 can be a reflective film coated on the light incident area 366.

While various exemplary and preferred embodiments have been described, it is to be understood that the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A backlight module comprising:
a light source;
a light guide plate comprising a top surface and a bottom surface at opposite sides thereof, and a circumferential side surface connecting the top surface with the bottom surface; and
a reflector covering the bottom surface and the side surface,
wherein the top surface comprises a light incident area and a light emitting area, the light source is positioned on the light incident area and emits light into the light guide plate, and the light is reflected by the reflector at the bottom surface and the side surface and emits out of the light guide plate from the light emitting surface.

2. The backlight module of claim 1, wherein the light incident area is coplanar with the light emitting area.

3. The backlight module of claim 1, wherein the top surface is rectangular, the light incident area is a narrow rectangular area adjacent to a long edge of the top surface, a length of the light incident area is equal to a length of the edge of the top surface, and the remaining area of the top surface is the light emitting area.

4. The backlight module of claim 1, wherein the reflector is a sheet made of a material with high reflectance, and comprises a flat first part covering the bottom surface and a circumferential second part covering the side surface.

5. The backlight module of claim 4, wherein the first part and the second part are integrally formed.

6. The backlight module of claim 4, wherein the light source comprises a circuit board and a plurality of illuminants formed on the circuit board, each of the illuminants comprises a light emitting surface facing away from the circuit board, and the light emitting surfaces are in contact with the light incident area of the top surface.

7. The backlight module of claim 6, wherein the reflector further comprises a third part covering the light incident surface except for positions where the light emitting surfaces contact the light incident area.

8. The backlight module of claim 1, wherein the reflector is a reflective layer coated on the bottom surface and the side surface.

9. A liquid crystal display, comprising:
a liquid crystal panel;
a frame holding the liquid crystal panel;
a backlight module positioned below the liquid crystal panel, and comprising:
a light source;
a light guide plate comprising a top surface and a bottom surface at opposite sides thereof, and a side surface connecting the top surface with the bottom surface; and
a reflector covering the bottom surface and the side surface; and
a base holding the backlight module and the frame,
wherein the top surface comprises a light incident area and a light emitting area, the light source is positioned on the light incident area and emits light into the light guide plate, and the light is reflected by the reflector at the bottom surface and the side surface and emits out of the light guide plate from the light emitting surface.

10. The liquid crystal display of claim 9, wherein the frame comprises a plurality of sides connected end to end and a frame-shaped holding flange extending from an inner surface of the sides, the liquid crystal panel is held on the holding flange.

11. The liquid crystal display of claim 10, wherein the base comprises a bottom board and a plurality of side walls correspondingly extending upwards from a plurality of raised edges of the bottom board, the side walls do not connect with each other, rather, a number of cutouts are correspondingly defined between adjacent of the side walls, the side walls and the bottom board cooperatively define a receiving space to receive the backlight module and the frame.

12. The liquid crystal display of claim 11, wherein one of the side walls extends a holding board towards the opposite side wall, the holding board defines a plurality of receiving holes longitudinally along the holding board, the light source comprises a circuit board and a plurality of illuminants formed on the circuit board, each of the illuminants comprises a light emitting surface opposite to the circuit board, the circuit board is held on the holding board, the illuminants correspondingly passes through the receiving holes, the light emitting faces the bottom board.

13. The liquid crystal display of claim 12, wherein the light guide plate with the reflector attached thereon is positioned on the bottom board, a part of the light guide plate on which the light incident area is defined is inserted into a gap defined between the holding board and the bottom board, the light incident area is covered by the holding board, the light emitting surfaces of the illuminants are brought into contact with the light incident area.

14. The liquid crystal display of claim 12, wherein one of the sides is received in a space defined between the light guide plate, the opposite ends of the side wall opposite to the holding board extend out of the base at the corresponding cutouts, the other sides of the frame embrace the side walls of the base except for the side wall opposite to the holding board.

15. The liquid crystal display of claim 9, wherein the light incident surface is coplanar with the light emitting area.

16. The liquid crystal display of claim 9, wherein the top surface is rectangular, the light incident area is a rectangular area adjacent to an edge of the top surface, a length of the light incident area is equal to a length of the edge of the top surface, the remaining area of the top surface is the light emitting area.

17. The liquid crystal display of claim 9, wherein the reflector is a sheet made of a material with high reflectance and comprises a flat first part covering the bottom surface and a circumferential second part covering the side surface.

18. The liquid crystal display of claim 17, wherein the reflector further comprises a third covering the light incident surface except the positions where the light emitting surfaces touch the light incident area.

19. The liquid crystal display of claim 17, wherein the first part and the second part are integrally formed.

20. The liquid crystal display of claim 9, wherein the reflector is a reflective film coated on the bottom surface and the side surface.
